(19) United States
(12) Patent Application Publication
(10) Pub. No.: US 2023/0372172 A1
(43) Pub. Date: Nov. 23, 2023

(54) DISPOSABLE PATHOGEN CONTAINMENT DEVICE

(71) Applicants: Ana SJAUS, Halifax (CA); Matthew d'ENTREMONT, Lakeview (CA)

(72) Inventors: Ana SJAUS, Halifax (CA); Matthew d'ENTREMONT, Lakeview (CA)

(21) Appl. No.: 18/030,388

(22) PCT Filed: Oct. 6, 2021
(86) PCT No.: PCT/CA2021/000087

§ 371 Date: Apr. 5, 2023

(30) Foreign Application Priority Data
Oct. 7, 2020 (CA) 3095639

(51) Int. Cl. A61G 10/00; A61G 10/02

(52) U.S. Cl. CPC A61G 10/005; A61G 10/02

(57) ABSTRACT

A disposable pathogen containment device including a support frame structure. An enclosure made of a substantially air-tight flexible sheet material is mounted to the support frame structure. At least an access port is disposed in the enclosure with at least one of the at least an access port being adapted for enabling transmission of air into the enclosure. A suction structure is mounted to the enclosure. The suction structure comprises a suction connecting port adapted for being connected to a suction source and a suction conduit connected to the suction connecting port. The suction conduit comprises at least a suction opening for removing air from inside the enclosure. The at least a suction opening is placed such that air containing pathogen emitted from a pathogen emitting source disposed inside the enclosure is drawn away from the at least an access port.

This application is a national stage filing of PCT Application No. PCT/CA2021/000087 (corresponding to Publication No. WO 2022/174320) filed on Oct. 6, 2021 and entitled Disposable Pathogen Containment Device, which in turn claims priority to Canadian Patent Application No. 3095639 filed on Oct. 7, 2020 and entitled Disposable Pathogen Containment Device. The entire contents of both of these applications are hereby incorporated by reference.

### FIELD

The present disclosure relates to devices for containing pathogens, and more particularly to a disposable pathogen containment device for protecting medical practitioners by containing pathogens emitted from a patient's airways during airway management or other aerosol generating procedures.

### BACKGROUND

Various medical procedures such as, for example, intubations, require medical practitioners to interact with a patient's airways which typically generate droplets and/or aerosols emitted from the patient's airways, potentially exposing the medical practitioner to a high load of dangerous and contagious pathogens such as, for example, SARS-CoV-2, contained therein.

Presently, there are various passive and active enclosures available. The passive barriers have no air removal inside the enclosure, while active barriers have active internal suction for removing the air. Present-day enclosures include “aerosol box” designs such as solid wall boxes with access ports, plastic bags placed on top of a patient's head, or plastic drapes mounted to a support frame.

Passive enclosures concentrate the pathogens therein and prevent removal by room ventilation, thus exposing the medical practitioner and other hospital staff to the pathogens during and after removal of the passive enclosure from the patient. While active enclosures remedy this problem to some extent, there is still the risk of exposing the medical practitioner to pathogens that remained in the enclosure prior removal of the same.

If the enclosure is designed for re-use such as, for example, aerosol boxes, personnel is exposed to the pathogens that remained in the enclosure during handling and cleaning/disinfecting of the same, as well as a following patient in case the cleaning/disinfecting was ineffective.

Aerosol boxes and enclosures having a rigid frame structure additionally pose the risk of breaching a medical practitioner's Personal Protective Equipment (PPE) such as, for example, protective gloves when in contact therewith, as well as the risk of direct injury to a patient if a heavy and cumbersome structure is deployed over their head/face.

Furthermore, deployment and positioning of these enclosures on top of a patient's head can be an arduous and time-consuming task, possibly preventing use of the same in live-threatening situations where rapid action is of the essence.

It may be desirable to provide a disposable pathogen containment device that enables easy and rapid deployment and positioning thereof.

It also may be desirable to provide a disposable pathogen containment device that enables easy and safe disposal thereof after use and substantially contains remaining pathogens therein during handling thereof.

It also may be desirable to provide a disposable pathogen containment device that provides suction such that pathogen contaminated air inside the enclosure is drawn away from access openings disposed in the enclosure.

It also may be desirable to provide a disposable pathogen containment device that is flexible and minimizes interferences with medical procedures performed therein.

It also may be desirable to provide a disposable pathogen containment device that is of substantially smaller size prior deployment.

### SUMMARY

Accordingly, one aspect the present disclosure is to provide a disposable pathogen containment device that enables easy and rapid deployment and positioning thereof.

Another aspect of the present disclosure is to provide a disposable pathogen containment device that enables easy and safe disposal thereof after use and substantially contains remaining pathogens therein during handling thereof.

Another aspect of the present disclosure is to provide a disposable pathogen containment device that provides suction such that pathogen contaminated air inside the enclosure is drawn away from access openings disposed in the enclosure.

Another aspect of the present disclosure is to provide a disposable pathogen containment device that is flexible and minimizes interferences with medical procedures performed therein.

Another aspect of the present disclosure is to provide a disposable pathogen containment device that is of substantially smaller size prior deployment.

According to one aspect of the present disclosure, there is provided a disposable pathogen containment device. The disposable pathogen containment device comprises a support frame structure. An enclosure made of a substantially air-tight flexible sheet material is mounted to the support frame structure. At least an access port is disposed in the enclosure with at least one of the at least an access port being adapted for enabling transmission of air into the enclosure.

A suction structure is mounted to the enclosure. The suction structure comprises a suction connecting port adapted for being connected to a suction source and a suction conduit connected to the suction connecting port. The suction conduit comprises at least a suction opening for removing air from inside the enclosure. The at least a suction opening is placed such that air containing pathogen emitted from a pathogen emitting source disposed inside the enclosure is drawn away from the at least an access port.

According to an aspect of the present disclosure, there is provided a disposable pathogen containment device. The disposable pathogen containment device comprises a support frame structure. An enclosure made of a substantially air-tight flexible sheet material is mounted to the support frame structure. At least an access port is disposed in the enclosure with at least one of the at least an access port being adapted for enabling transmission of air into the enclosure.

A suction structure is mounted to the enclosure. The suction structure comprises a suction connecting port adapted for being connected to a suction source and a suction conduit connected to the suction connecting port. The suction conduit comprises at least a suction opening for removing air from inside the enclosure. The at least a suction opening is placed such that air containing pathogen emitted from a pathogen emitting source disposed inside the enclosure is drawn away from the at least an access port. A bottom wall of the enclosure comprises an access port adapted for transmitting a patient's head therethrough such that the patient's head is facing substantially upward. The enclosure comprises a front wall placed such that the same extends substantially upwardly from the patient's chest after the patient's head is placed inside the enclosure. The at least a suction opening is placed in a top front portion of the enclosure. The enclosure further comprises a rear wall with a top portion thereof being oriented upwardly and forwardly such that a top end thereof is placed approximately midpoint between a front end and a rear end of the enclosure. Two access ports are disposed in the top portion of the rear wall. The suction conduit comprises a tube extending approximately from a left hand side to a right hand side of the enclosure and wherein the at least a suction opening is adapted to provide suction at a plurality of locations along the tube.

According to an aspect of the present disclosure, there is provided a disposable pathogen containment device. The disposable pathogen containment device comprises a support frame structure. An enclosure made of a substantially air-tight flexible sheet material is mounted to the support frame structure. At least an access port is disposed in the enclosure with at least one of the at least an access port being adapted for enabling transmission of air into the enclosure.

A suction structure is mounted to the enclosure. The suction structure comprises a suction connecting port adapted for being connected to a suction source and a suction conduit connected to the suction connecting port. The suction conduit comprises at least a suction opening for removing air from inside the enclosure. The at least a suction opening is placed such that air containing pathogen emitted from a pathogen emitting source disposed inside the enclosure is drawn away from the at least an access port. The support frame structure is made of flexible sheet material and is inflatable. The support frame structure is connected to an inflation port. The support frame structure and the enclosure are adapted to enable folding of the same such that the inflation port is accessible when the same are folded. The support frame structure and the enclosure are adapted such that inflation unfolds the same.

According to an aspect of the present disclosure, there is provided a method for containing pathogen. The method comprises providing a folded disposable pathogen containment device. The device comprises an inflatable support frame structure. An enclosure made of a substantially air-tight flexible sheet material is mounted to the support frame structure. At least an access port is disposed in the enclosure. A suction structure mounted to the enclosure. The suction structure comprising a suction connecting port adapted for being connected to a suction source and a suction conduit connected to the suction connecting port. The conduit comprises at least a suction opening for removing air from inside the enclosure. The support frame structure is inflated and forms the enclosure. The suction connecting port is connected to a suction source. A pathogen emitting source is disposed through an access port inside the enclosure. Suction is provided to the suction connecting port. Air is removed from inside the enclosure. Simultaneously air is drawn from the outside into the enclosure through at least one of the at least an access port.

According to an aspect of the present disclosure, there is provided a method for containing pathogen. The method comprises providing a folded disposable pathogen containment device. The device comprises an inflatable support frame structure. An enclosure made of a substantially air-tight flexible sheet material is mounted to the support frame structure. At least an access port is disposed in the enclosure. A suction structure mounted to the enclosure. The suction structure comprising a suction connecting port adapted for being connected to a suction source and a suction conduit connected to the suction connecting port. The suction conduit comprises at least a suction opening for removing air from inside the enclosure. The support frame structure is inflated and forms the enclosure. The suction connecting port is connected to a suction source. A pathogen emitting source is disposed through an access port inside the enclosure. Suction is provided to the suction connecting port. Air is removed from inside the enclosure. Simultaneously air is drawn from the outside into the enclosure through at least one of the at least an access port. After use the pathogen emitting source is removed from the enclosure through the access port. The pathogen containment device is collapsed by deflating the support frame structure while simultaneously removing air from inside the enclosure. The suction source is disconnected from the suction connecting port and the collapsed pathogen containment device is disposed.

An advantage of the present disclosure is that it provides a disposable pathogen containment device that enables easy and rapid deployment and positioning thereof.

A further advantage of the present disclosure is that it provides a disposable pathogen containment device that enables easy and safe disposal thereof after use and substantially contains remaining pathogens therein during handling thereof.

A further advantage of the present disclosure is that it provides a disposable pathogen containment device that provides suction such that pathogen contaminated air inside the enclosure is drawn away from access openings disposed in the enclosure.

A further advantage of the present disclosure is that it provides a disposable pathogen containment device that is flexible and minimizes interferences with medical procedures performed therein.

A further advantage of the present disclosure is that it provides a disposable pathogen containment device that is of substantially smaller size prior deployment.

### BRIEF DESCRIPTION OF THE DRAWINGS

An embodiment is described below with reference to the accompanying drawings, in which:

FIG. 1a is a simplified block diagram illustrating in a perspective view a disposable pathogen containment device according to an embodiment;

FIG. 1b is a simplified block diagram illustrating in a perspective view a suction structure of the disposable pathogen containment device according to an embodiment;

FIG. 1c is a simplified block diagram illustrating in a front bottom perspective view the disposable pathogen containment device according to an embodiment;

FIG. 1d is a simplified block diagram illustrating in a side perspective view the disposable pathogen containment device according to an embodiment;

FIG. 1e is a simplified block diagram illustrating in a front perspective view the disposable pathogen containment device according to an embodiment;

FIG. 1f is a simplified block diagram illustrating in a front view an access port of the disposable pathogen containment device according to an embodiment;

FIG. 2a is a simplified block diagram illustrating in a rear side perspective view placement on a patient's head of the disposable pathogen containment device according to an embodiment;

FIG. 2b is a simplified block diagram illustrating in a front top perspective view placement on a patient's head of the disposable pathogen containment device according to an embodiment;

FIG. 2c is a simplified block diagram illustrating in a side bottom perspective view placement on a patient's head of the disposable pathogen containment device according to an embodiment;

FIG. 3a is a simplified block diagram illustrating in a side perspective view air flow inside the enclosure of the disposable pathogen containment device according to an embodiment; and,

FIG. 3b is a simplified block diagram illustrating in a rear side perspective view distribution of pathogen containing air inside the enclosure of the disposable pathogen containment device according to an embodiment.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to employment of the same for protecting a medical practitioner during and after aerosol generating procedures such as, for example, airway management, upper gastrointestinal tract endoscopy, trans esophageal echocardiography, dentistry, facial cosmetic procedures, it will become evident to those skilled in the art that the embodiments of the invention are not limited thereto, but are also employable for temporary isolation of an infected patient and adaptable, for example, for use as a portable and disposable isolation hood for manipulating infectious samples and as a portable and disposable bio-safety cabinet.

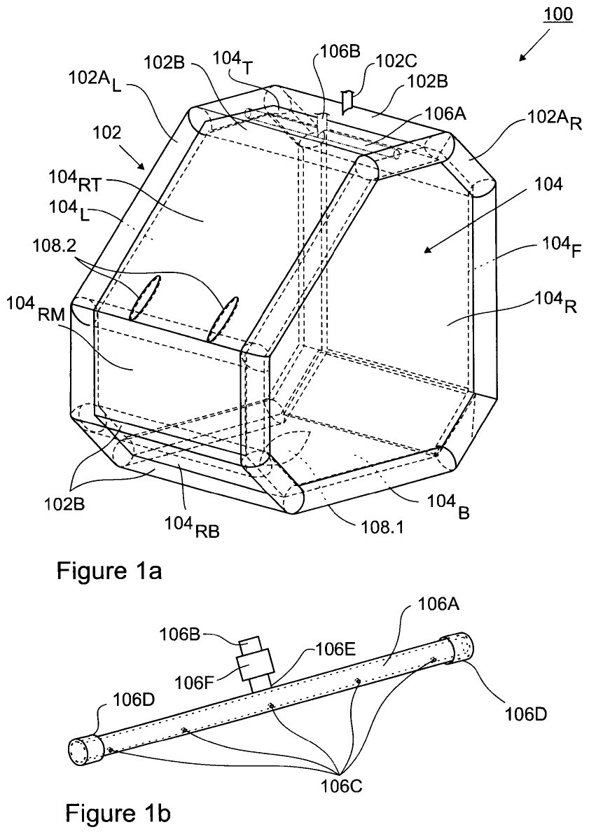

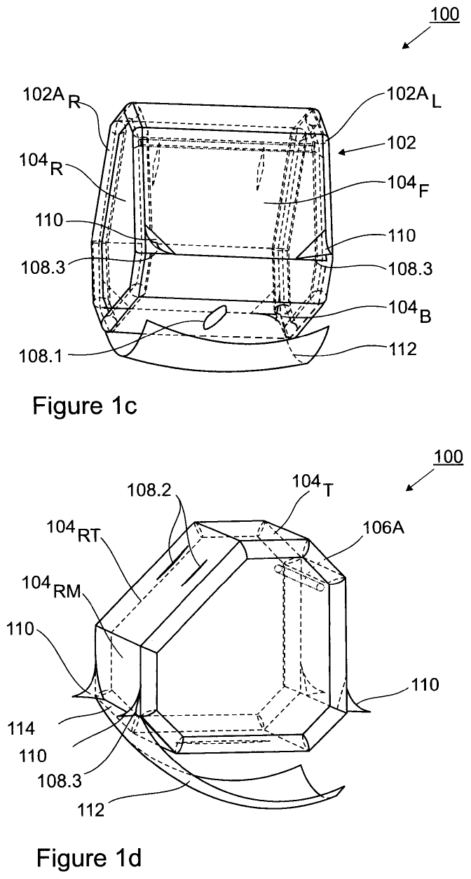

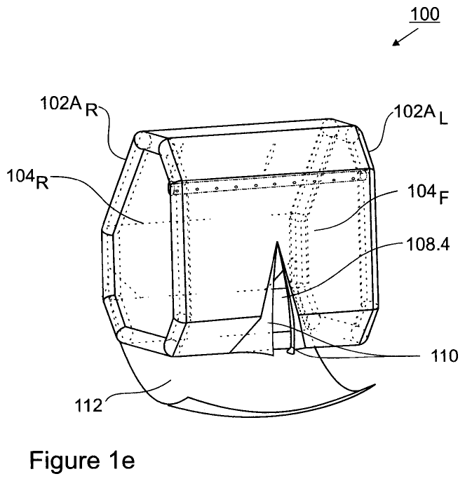

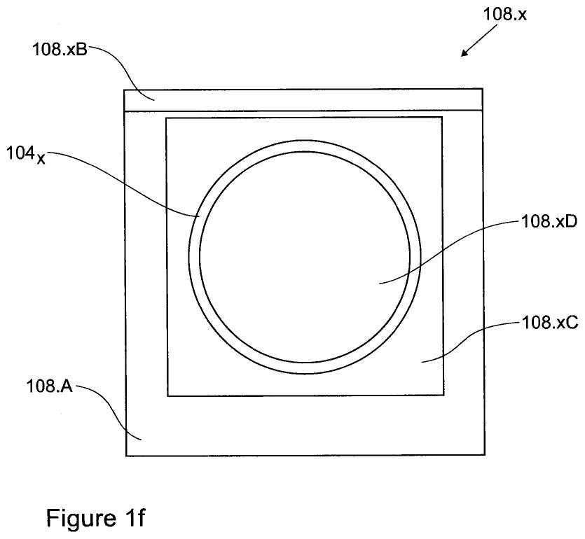

Referring to FIGS. 1a to 1f, 2a to 2c, 3a, and 3b, a disposable pathogen containment device 100 according to an embodiment is provided. The disposable pathogen containment device 100 comprises support frame structure 102 having enclosure 104 made of a substantially air-tight flexible sheet material mounted thereto. At least an access port 108.x is disposed in the enclosure with at least one of the at least an access port 108.x being adapted for enabling transmission of ambient air into the enclosure 104. A suction structure is mounted to the enclosure 104. The suction structure comprises a suction connecting port 106B adapted for being connected to a suction source and a suction conduit 106A connected to the suction connecting port 106B. The suction conduit 106A comprises at least a suction opening 106C for removing air from inside the enclosure 104. The at least a suction opening 106C can be placed such that air containing pathogen emitted from a pathogen emitting source disposed inside the enclosure 104 is drawn away from the at least an access port 108.x, as will be described hereinbelow.

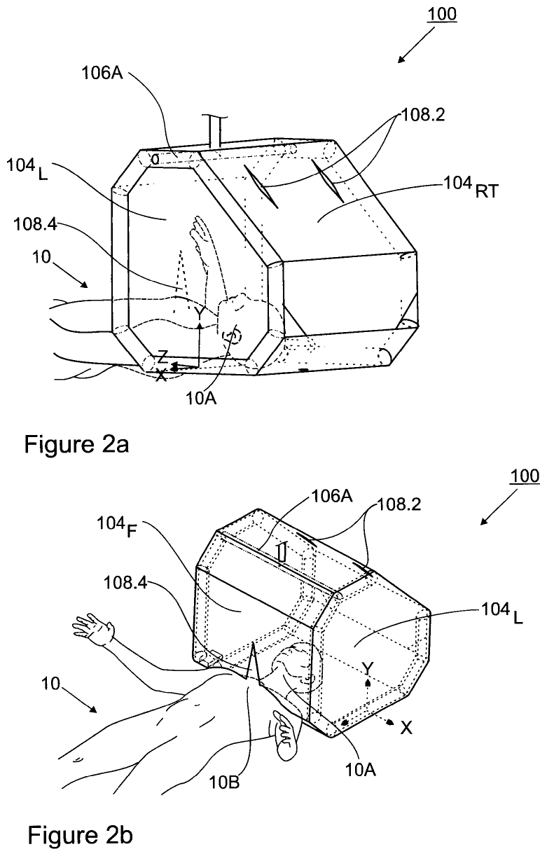

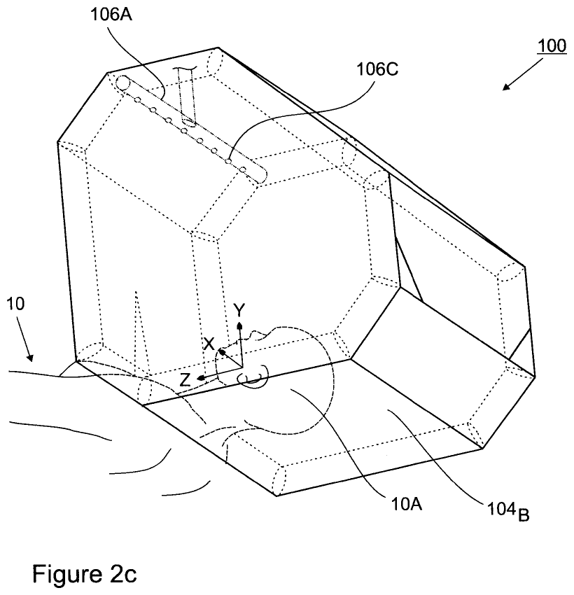

An access port 108.1 can be disposed in bottom wall 104B of the enclosure 104. The access port 108.1 is adapted for transmitting a patient's head 10A therethrough such that the patient's head 10A is facing substantially upward, as illustrated in FIGS. 2a to 2c. Front wall 104_{F} of the enclosure 104 can be placed such that the same extends substantially upwardly from the patient's upper chest 10B after the patient's head 10A is placed inside the enclosure 104. For example, the at least a suction opening 106C is placed in a top front portion of the enclosure 104, as will be described in more detail hereinbelow. The enclosure 104 can comprise a rear wall having a bottom portion 104_{RB}, a mid section 104_{RM}, and a top portion 104_{RT} with the top portion 104_{RT} thereof being oriented upwardly and forwardly such that a top end thereof is placed approximately midpoint between the front wall 104_{F} end and the rear wall mid section 104_{RM} of the enclosure 104. As illustrated, the disposable pathogen containment device 100 comprises two access ports 108.2 disposed in the rear wall top portion 104_{RT} to enable access for the medical practitioner to the patient's head 10A. The placement of the access ports 108.2 is chosen to enable access to the patient's head 10A for medical procedures such as, for example, airway management. As is evident, the placement of the access ports is not limited thereto but may be at different locations such as, for example, in the left hand side wall 104_{L} and/or the right hand side wall 104_{R}, or various other locations, or combinations thereof, to enable access to the patient's head 10A for different medical procedures such as, for example, dentistry or facial cosmetic procedures.

Optionally, further access ports 108.3 and 108.4 are provided for enabling provision of tubing and medical devices such as, for example, intubation devices or endoscopes into the enclosure 104.

At least some of the access ports 108.x can be sealable/re-sealable using, for example, conventional peel and stick covers 110, in order to control ingress of ambient air into the enclosure, as well as to prevent egress of pathogen containing air from the enclosure 104.

Larger access ports 108.x can be covered by flaps 108.xA made of, for example, a same plastic sheet material as the enclosure 104, and mounted to the outside surface of the respective enclosure wall 104, at area 108.xB using, for example, an adhesive. During operation the flap 108.xA is easily lifted for enabling access to the inside of the enclosure 104 through the opening 108.xD, while the same easily covers the opening 108.xD in a sealed manner when not in use since the air pressure inside the enclosure 104 is lower than the ambient air pressure.

Double-sided adhesive tape 108.xC surrounding the opening 108.xD can be adhered to the outside surface of the respective enclosure wall 104ₓ. Prior collapsing of the disposable pathogen containment device 100 for disposal, the cover layer of the double-sided adhesive tape 108.xC is removed to expose the adhesive. The flap 108.xA is then pressed onto the double-sided adhesive tape 108.xC for permanently sealing the opening 108.xD to prevent egress of pathogen containing air during collapsing and disposal of the disposable pathogen containment device 100.

The flap 108.xA and the double-sided adhesive tape 108.xC may be adapted to cover openings 108.xD having various shapes and sizes. Furthermore, the flap 108.xA may also be adapted to cover more than one opening 108.xD.

Alternatively, larger access ports may be provided, for example, with a Zipper closure.

Optionally, a securing flap 112 is mounted to an outside rear bottom end portion 114 of the enclosure 104 and extends forwardly. The securing flap 112 is adapted for being placed underneath a pillow before the patient's head 10A is rested thereupon. The weight of the patient's head 10A and a portion of the patient's upper body 10B exerted on the securing flap 112 substantially holds the same in a fixed location and orientation, as well as the enclosure 104 connected thereto.

The suction conduit 106A can comprise a tube—having, for example, a circular cross section—extending approximately from the left hand side wall 104_{L} to the right hand side wall 104_{R}. The tube is, for example, connected to the suction connecting port 106B via T-section 106E placed at the center of the tube. The ends of the tube are sealed via caps 106D. Suction to the enclosure 104 is provided, for example, via a plurality of suction openings 106C disposed along the tube, in one case, in an equidistant fashion. Alternatively, suction is provided at a plurality of locations along the tube using a slit extending along the tube. The suction connecting port 106B is adapted for being connected to, for example, a wall supplied medical vacuum, a mechanical pump, or a compressed air Venturi style pump.

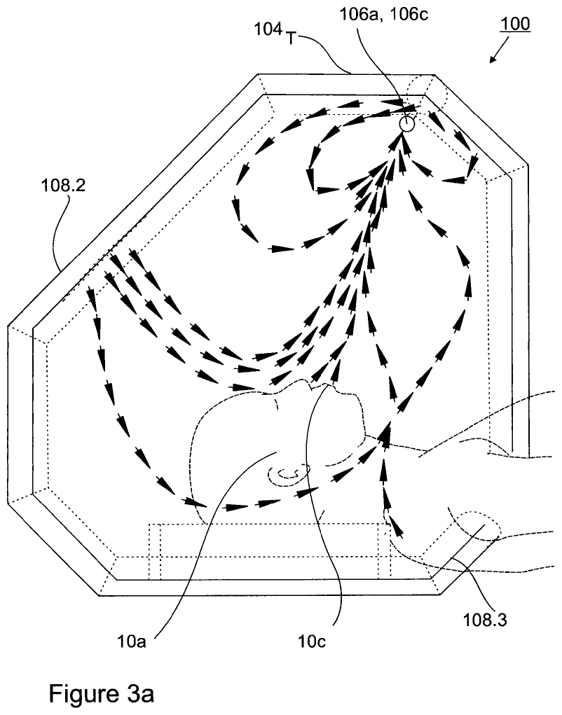

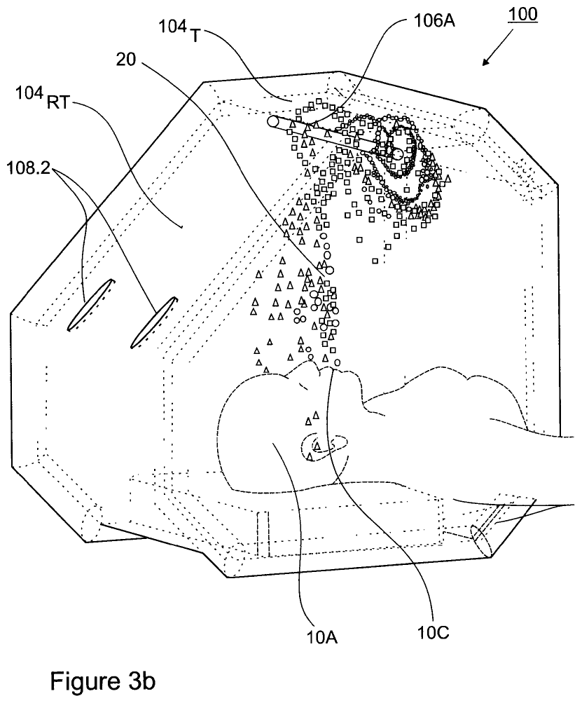

Computer simulations have revealed that provision of suction along a line provides a steadier air flow inside the enclosure 104 and, therefore, a more controlled removal of the air from the enclosure 104 than provision of suction at a single point. With the suction openings 106C being placed in a top front portion of the enclosure 104 in close proximity to the top wall 104T of the enclosure 104, ambient air drawn into the enclosure 104 via access ports 108.1 and 108.2 flows away from the patient's head 10A, as well as air emitted from the patient's mouth 10C, and is directed away from the access ports, and towards the top front portion of the enclosure 104 and the suction openings 106C, as indicated by the arrows in FIG. 3a. As illustrated in FIG. 3b, the air flow concentrates pathogen containing air 20 emitted from the patient's mouth 10C along a substantially straight path towards the top front portion of the enclosure 104 and the suction openings 106C, thus substantially preventing egress of pathogen containing air 20 through the access ports and protecting the medical practitioner while performing medical procedures inside the enclosure 104.

It is noted that the shape of the disposable pathogen containment device 100 as described herein has been developed to provide pathogen containment during airway management procedures such as, for example, intubation, while facilitating operator and assistant access as well as enabling simultaneous lower truck/body surgery on the patient 10. The shape of the disposable pathogen containment device 100 may be adapted for use during different medical procedures such as, for example, endoscopy, dentistry, and temporary isolation.

Optionally, pathogen filter 106F is interposed between the T-section 106E and the suction connecting port 106B. The pathogen filter 106F is, for example, a commercially available High Efficiency Particle Air (HEPA) filter or a commercially available Ultra Low Penetration Air (ULPA) filter. Alternatively, a pathogen filter may be interposed between the suction connecting port 106B and the suction source, or disposed in the suction conduit 106A.

The support frame structure 102 can be made of a flexible sheet material and is inflatable. For example, the support frame structure 102 comprises inflatable tubular support frame elements 102A, 102B which are in fluid communication with each other. One of the support frame elements, here 102B, is connected to an inflation port 102C. The support frame elements form, for example: a left hand side frame 102A_{L} outlining a left hand side 104_{L} of the enclosure 104; a right hand side frame 102A_{R} outlining a right hand side 104_{R} of the enclosure 104; and, connecting elements 102B connecting the left hand side frame 102A_{L} and the right hand side frame 102A_{R}. The support frame structure 102 and the enclosure 104 can be adapted to enable folding of the same such that the inflation port 102C is accessible when the same are folded and such that the support frame structure 102 and the enclosure 104 are unfolded during inflation. For example, with the inflation port 102C placed as illustrated in FIG. 1a, the support frame structure 102 and the enclosure 104 may be rolled up forming a cylindrical roll oriented substantially parallel to the tube 106A.

The inflation port 102C is, for example, a commercially available valve stem port adapted for being connected to a hand pump, a compressed air supply of the hospital, or a one time use CO₂ canister.

Alternatively, the support frame structure 102 may be made of rigid support elements having the enclosure 104 mounted thereto, for example, similar to a “pop-up” tent structure.

The support frame structure 102, the enclosure 104, and the flaps 110, can be made of a clear transparent thermoplastic polymer such as, for example, Low Density PolyEthylene (LDPE), provided as sheet material having 3-6 MTh weight, which is heat welded in a conventional manner to form the support frame structure 102, the enclosure 104, and the flaps 110, as well as to mount the tube 106A, the suction connecting port 106B, and the inflation port 102C thereto. The tube 106A is made of, for example, a substantially rigid PolyEthylen (PE) or PolyPropylene (PP) plastic material.

Provision of the inflatable support frame structure 102 enables easy and rapid deployment of the disposable pathogen containment device 100 by simply connecting the inflation port 102C to an inflation source such as, for example, a one-time use CO₂ canister and inflating the support frame structure 102. During inflation, the support frame structure 102 and the enclosure 104 are simultaneously unfolded and form the disposable pathogen containment device 100 with increased inflation. After inflation the suction connecting port 106B is connected to a suction source and suction is provided thereto. Then the patient's head 10A is disposed through access port 108.1 in the bottom wall 104B into the enclosure 104 and the securing flap 112 is placed underneath the patient's pillow before the patient's head 10A is rested on the pillow. Alternatively, the flap 112 can be tucked under the pillow without moving the patient's head. The medical practitioner is now enabled to perform the medical procedure inside the enclosure 104 while air is removed from inside the enclosure 104 and simultaneously ambient air is drawn from the outside into the enclosure 104 through the access ports 108.1 and 108.2.

With the support frame structure 102 and the enclosure 104 being made of flexible sheet material and the top portion 104_{RT} of the rear wall being oriented upwardly and forwardly, the disposable pathogen containment device 100 is flexible and minimizes interferences with medical procedures performed in the enclosure 104. Furthermore, the disposable pathogen containment device 100 is foldable to a substantially smaller size prior deployment.

After use, the disposable pathogen containment device 100 is removed from the patients head 10A and collapsed by deflating the support frame structure while simultaneously removing air from inside the enclosure 104. The disposable pathogen containment device 100 can be slowly removed from the patients head 10A in order to prevent aerosolization of pathogen contained in droplets that may adhere to the inner walls of the enclosure 104. After the disposable pathogen containment device 100 is collapsed the suction source is disconnected from the suction connecting port 106B and the disposable pathogen containment device 100 is disposed according to hospital procedures. It is noted that the disconnection should occur in the clean part of the suction circuit, i.e. between the pathogen filter 106F and the suction source. The disposable pathogen containment device 100 enables easy and safe disposal after use and substantially contains remaining pathogens therein during removal from the patient's head 10A and collapsing of the device.

The present invention has been described herein with regard to certain embodiments. However, it will be obvious to persons skilled in the art that a number of variations and modifications can be made without departing from the scope of the invention as described herein.

What is claimed is:

The embodiments of the invention in which an exclusive property or privilege is claimed are defined as follows:

1. A disposable pathogen containment device comprising:
a support frame structure;
an enclosure made of a substantially air-tight flexible sheet material mounted to the support frame structure;
at least an access port disposed in the enclosure with at least one of the at least an access port being adapted for enabling transmission of air into the enclosure; and,
to a suction structure mounted to the enclosure, the suction structure comprising a suction connecting port adapted for being connected to a suction source and a suction conduit connected to the suction connecting port, the suction conduit comprising at least a suction opening for removing air from inside the enclosure, the at least a suction opening being placed such that air containing pathogen emitted from a pathogen emitting source disposed inside the enclosure is drawn away from the at least an access port.

2. The device according to claim 1 wherein a bottom wall of the enclosure comprises an access port adapted for transmitting a patient's head therethrough such that the patient's head is facing substantially upward and wherein the at least a suction opening is placed in a top end portion of the enclosure.

3. The device according to claim 2 wherein the enclosure comprises a front wall placed such that the same extends substantially upwardly from the patient's chest after the patient's head is placed inside the enclosure and wherein the at least a suction opening is placed in a top front portion of the enclosure.

4. The device according to claim 3 wherein the enclosure comprises a rear wall with a top portion thereof being oriented upwardly and forwardly such that a top end thereof is placed approximately midpoint between a front end and a rear end of the enclosure.

5. The device according to claim 4 wherein the top portion of the rear wall comprises two access ports disposed therein.

6. The device according to claim 2 wherein the suction conduit comprises a tube extending approximately from a left hand side to a right hand side of the enclosure and wherein the at least a suction opening is adapted to provide suction at a plurality of locations along the tube.

7. The device according to claim 6 wherein the tube comprises a plurality of suction openings disposed along the tube.

8. The device according to claim 2 comprising a securing flap mounted to an outside rear bottom end portion of the enclosure and extending forwardly, the securing flap being adapted for being placed underneath the patient's pillow.

9. The device according to claim 1 wherein the support frame structure is made of flexible sheet material and is inflatable.

10. The device according to claim 9 wherein the support frame structure comprises inflatable tubular support frame elements.

11. The device according to claim 10 wherein the support frame elements are in fluid communication with each other and wherein one of the support frame elements is connected to an inflation port.

12. The device according to claim 11 wherein the support frame elements form:
a left hand side frame outlining a left hand side of the enclosure;
a right hand side frame outlining a right hand side of the enclosure; and,
connecting elements connecting the left hand side frame and the right hand side frame.

13. The device according to claim 9 wherein the support frame structure is connected to an inflation port and wherein the support frame structure and the enclosure are adapted to enable folding of the same such that the inflation port is accessible when the same are folded and wherein the support frame structure and the enclosure are adapted such that inflation unfolds the same.

14. The device according to claim 1 wherein at least one of the at least an access port is sealable.

15. The device according to claim 1 wherein the suction structure comprises a pathogen filter.

16. A method for containing pathogen comprising:
providing a folded disposable pathogen containment device, the device comprising:
an inflatable support frame structure;
an enclosure made of a substantially air-tight flexible sheet material mounted to the support frame structure;
at least an access port disposed in the enclosure; and,
a suction structure mounted to the enclosure, the suction structure comprising a suction connecting port adapted for being connected to a suction source and a suction conduit connected to the suction connecting port, the suction conduit comprising at least a suction opening for removing air from inside the enclosure;
inflating the support frame structure and forming the enclosure;
connecting the suction connecting port to a suction source;
disposing through an access port a pathogen emitting source inside the enclosure;
providing suction to the suction connecting port; and,
removing air from inside the enclosure and simultaneously drawing air from the outside into the enclosure through at least one of the at least an access port.

17. The method according to claim 16 comprising:
removing the pathogen emitting source from the enclosure through the access port;
collapsing the pathogen containment device by deflating the support frame structure while simultaneously removing air from inside the enclosure;
disconnecting the suction source from the suction connecting port; and,
disposing the collapsed pathogen containment device.

18. The method according to claim 17 wherein during inflating the support frame structure the disposable pathogen containment device is simultaneously unfolded.

19. The method according to claim 16 wherein a patient's head is disposed through an access port in a bottom wall of the enclosure.

20. The method according to claim 19 comprising placing a securing flap underneath the patient's pillow, the securing flap being mounted to an outside bottom end portion of the enclosure.
